(19) United States
(12) Patent Application Publication
(10) Pub. No.: US 2024/0035873 A1
(43) Pub. Date: Feb. 1, 2024

(54) HIGH-FREQUENCY MODULE FOR A LEVEL METER

(71) Applicant: Endress+Hauser SE+Co. KG, Maulburg (DE)

(72) Inventors: Eric Bergmann, Steinen (DE); Dirk Oßwald, Schopfheim (DE)

(21) Appl. No.: 18/256,977

(22) PCT Filed: Nov. 26, 2021
(86) PCT No.: PCT/EP2021/083096

§ 371 Date: Jun. 12, 2023

(30) Foreign Application Priority Data
Dec. 11, 2020 (DE) 10 2020 133 198.3

(51) Int. Cl. G01F 23/284

(52) U.S. Cl. CPC G01F 23/284

(57) ABSTRACT

A high-frequency module for radar-based level meters is based upon a transceiver unit for generating the radar signals and for determining the fill-level from corresponding received signals. The transceiver unit is enclosed for explosion protection purposes by an electronics encapsulation. A waveguide segment is connected to the transceiver unit to transmit the radar signals out of the electronics encapsulation to the outside. The waveguide segment is attached to a feedthrough of the electronics encapsulation such that the waveguide segment is guided out of the electronics encapsulation. The transceiver unit or the printed circuit board which carries it is thereby not attached directly to the electronics encapsulation, but in a free-standing manner to the waveguide segment. The printed circuit board can be made very compact since no space is required for further fastenings. As a result, the high-frequency module can be designed to be very compact overall.

The invention relates to a high-frequency module for level meters which can be made compact and modular.

In process automation, corresponding field devices are used for capturing relevant process parameters. For the purpose of capturing the different process parameters, suitable measuring principles are therefore implemented in the corresponding field devices, in order to capture as process parameters such as a fill-level, a flow, a pressure, a temperature, a pH value, a redox potential, or a conductivity. A wide variety of such field devices are manufactured and distributed by the Endress+Hauser company.

For measuring the fill-level of filling materials in containers, contactless measuring methods have become established, because they are robust and require minimum maintenance. A further advantage of contactless measuring methods consists in the ability to be able to measure the fill-level quasi-continuously. Radar-based measuring methods are therefore predominantly used in the field of continuous fill-level measurement (in the context of this patent application, “radar” refers to signals or electromagnetic waves with frequencies between 0.03 GHz and 300 GHz). An established measurement method is FMCW (“frequency-modulated continuous wave”). The FMCW-based fill-level measuring method is described, for example, in published patent application DE 10 2013 108 490 A1.

In principle, the antenna arrangement of radar-based level meters should be attached to the tank interior with direct contact, since no barrier that is impermeable to radar signals may be present between the antenna arrangement and the filling material. The electronic modules of the level meter, such as the radar-specific high-frequency module for high-frequency signal generation, and also further units for data processing and transmission, are accommodated outside the tank in a separate device housing. This is because, especially for explosion protection purposes, a spatial separation between the active modules, i.e., the modules supplied with electricity, and the passive antenna arrangement is often required. For this purpose, the device housing comprises a meter neck, via which the antenna arrangement is mechanically connected to the device housing. In this case, a corresponding explosion protection barrier is arranged in the meter neck of the antenna arrangement. In addition or as an alternative to explosion protection requirements, the meter neck may have to fulfill further protective functions. Depending upon the application, high temperatures, high pressure, or hazardous gases may occur inside the tank. Therefore, the meter neck must function as a pressure seal, temperature barrier, and/or as a media seal, depending upon the application.

So that the device housing and the (interface-)modules located therein can also serve as a platform for further field device types, in addition to level meters, and so that the device housing can be designed to be more compact overall, the high-frequency module, which is specifically for radar-based level meters, can be transferred to the meter neck. However, the spatial conditions in the meter neck are extremely limited due to thermal requirements and requirements specifically for explosion protection. For this reason, accommodation of the radar-specific high-frequency module in the meter neck is difficult. Particularly in the case of a modular design, the connection of the high-frequency module to the antenna arrangement is also challenging, since the connection must be designed to be releasable, and any plug connections between the corresponding waveguide segments increase the risk of high-frequency interference.

The object of the invention is therefore to provide a level meter which can be made compact and modular.

The invention achieves this object by a high-frequency module for radar-based level meters. The high-frequency module comprises the following components:
a transceiver unit, which is designed
   to generate corresponding radar signals according to a defined measuring principle, and,
   after reflection of the radar signals on the filling material surface, to determine the fill-level by means of corresponding received signals, according to the measuring principle,
an electronics encapsulation in which the transceiver unit is arranged, wherein the encapsulation makes it possible to close off the transceiver unit and the waveguide segment for explosion protection purposes by means of a corresponding potting compound, and
a waveguide segment connected to the transceiver unit in order to transmit the radar signals.

The waveguide segment is attached to a feedthrough of the electronics encapsulation in such a manner that the waveguide segment is guided out of the electronics encapsulation. According to the invention, the transceiver unit is at least indirectly attached to the waveguide segment by means of a corresponding fastening means.

By means of this attachment according to the invention, the transceiver unit or the printed circuit board to which it is attached is self-supporting within the electronics encapsulation. In the context of the invention, the transceiver unit can also be arranged on a printed circuit board, so that the transceiver unit is attached to the waveguide segment via the printed circuit board. This indirect fixation of the transceiver unit to the electronics encapsulation via the waveguide segment makes it possible to dispense with a direct attachment of the transceiver unit (or the printed circuit board) to the electronics encapsulation. As a result, the printed circuit board and thus the electronics encapsulation can be designed to be very compact, so that the high-frequency module can also be designed to be more compact overall. This in turn simplifies the accommodation of the high-frequency module in the level meter.

The terms, “unit” or “module,” in the context of the invention are primarily used to mean any electronic circuit that is designed for the intended purpose—for example, for high-frequency generation or as an interface. Depending upon the requirements, the corresponding unit may therefore comprise an analog circuit for generating or processing corresponding analog signals. However, it may also comprise a digital circuit, such as an FPGA, or a storage medium in interaction with a program. In this case, the program is designed to perform the corresponding method steps or to apply the necessary calculation operations of the respective unit. In this context, various electronic units or modules of the meter in the sense of the invention can potentially also access a common physical memory or be operated by means of the same physical digital circuit. Specifically, the transceiver unit, for activating the antenna arrangement via the waveguides can be based, for example, upon the FMCW or the pulse transit time method.

In the context of the invention, it is not concretely specified how the waveguide segment, and thus, indirectly, also the transceiver unit, is attached to the feedthrough of the electronics encapsulation. For example, the waveguide segment can be fastened to the feedthrough of the electronics encapsulation by means of a screw connection. In this case, a possible screw connection can be designed in particular with an external thread which is oriented along the waveguide axis in such a way along the waveguide segment that the waveguide segment is countered by a corresponding nut against the feedthrough of the electronics encapsulation.

On the basis of the high-frequency module according to the invention, a radar-based level meter can be realized for determining a fill-level of a filling material. In addition to the high-frequency module according to one of the previously described embodiment variants, the level meter has the following components:
an antenna arrangement which can be activated via a high-frequency connection, such that
   the radar signal can be emitted towards the filling material, and
   a such that, after reflection of the radar signal on the filling material surface, a received signal can be received, and
a device housing, connected to the antenna arrangement or the high-frequency connection, in which the high-frequency module is arranged in such a manner that the waveguide segment connects with a positive connection along a common waveguide axis to the high-frequency connection or a galvanic isolation which is inserted on both ends between the high-frequency connection and the waveguide segment.

If the device housing is connected to the antenna arrangement via a meter neck for the purpose of thermal decoupling from the antenna arrangement, in the context of the invention, the high-frequency module can be arranged in particular in the meter neck of the device housing, since the electronics module can be designed to be very compact according to the invention.

For a low-loss transmission of the radar signal, it is necessary for the high-frequency connection and the waveguide segment of the high-frequency module to be matched to the corresponding frequency or mode of the radar signal. In this regard, the high-frequency connection and the waveguide segment can, in the context of the invention, be designed, for example, as a waveguide with a correspondingly dimensioned cross-section.

The invention is explained in more detail with reference to the following figures. In the figures:

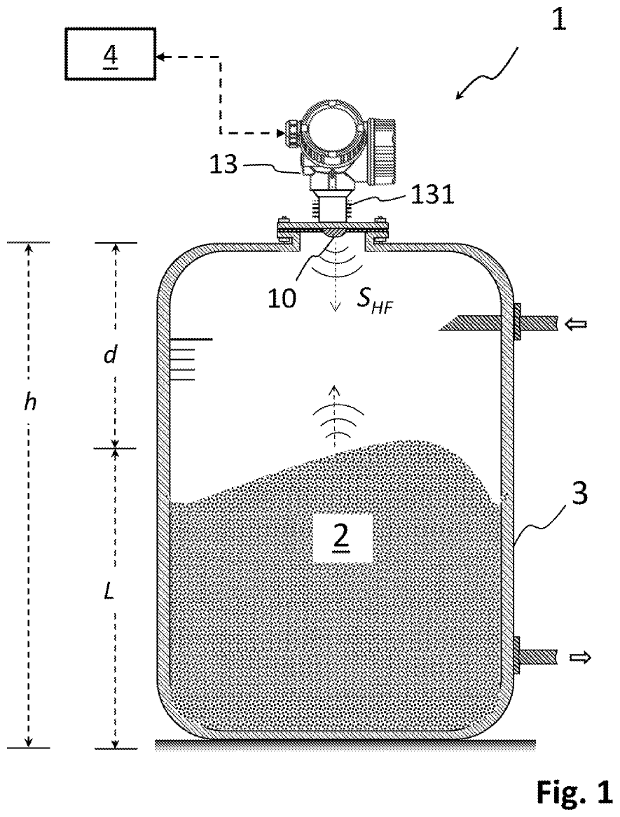

FIG. 1: is a radar-based level meter on a tank,

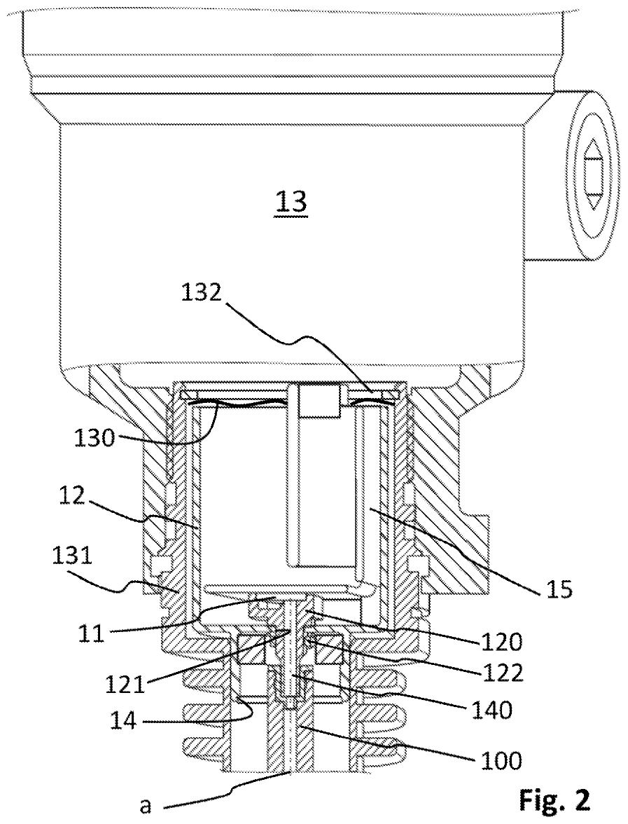

FIG. 2: is a cross-sectional view of a level meter according to the invention, and

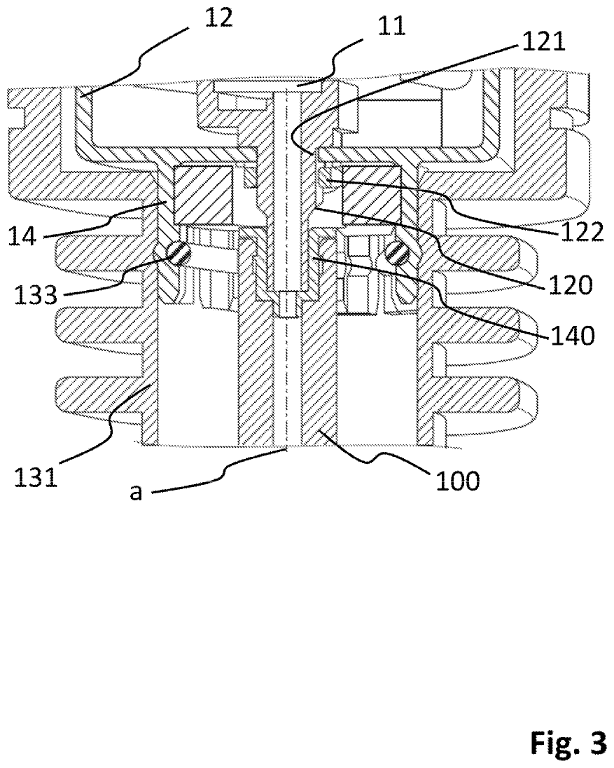

FIG. 3: is a detail view of the level meter in the region of the waveguide segment.

For the basic understanding of radar-based fill-level measurement, FIG. 1 shows a container 3 with a filling material 2, the fill-level L of which is to be determined. The tank 3 can be up to more than 100 m high, depending upon the type of filling material 2 and field of application. The conditions in the tank 3 are also dependent upon the type of filling material 2 and the field of application. In the case of exothermic reactions, for example, high temperature and pressure stresses can occur. In the case of dust-containing or flammable substances, appropriate explosion protection conditions must be observed in the tank interior.

To be able to determine the fill-level L independently of the prevailing conditions, a radar-based level meter 1 is attached to the tank 3 at a known installation height h above the filling material 2. In this case, the level meter 1 is fastened to or oriented towards a corresponding (flange) opening of the tank 3 in such a way that an antenna arrangement 10 of the level meter 1 is directed vertically into the tank 3 towards the filling material 2. The remaining device housing 13 of the level meter 1, in which the electronic components 11 are accommodated, is arranged outside the tank feedthrough. Due to the spatial separation of the electronic components 11 in the device housing 13 from the antenna arrangement 10 or from the tank interior by a meter neck 131, explosion protection within the tank 3 is, on the one hand, ensured. On the other hand, the electronic components 10 in the device housing 13 or in the meter neck 131 are protected from temperature and pressure stresses from the tank interior. As is indicated in FIG. 1 and FIG. 2, the meter neck 131 has appropriate cooling ribs for thermal decoupling of the device housing 13.

As a result of the arrangement on the tank 3, it is possible for the level meter 1 to emit radar signals S_{HF} vertically in the direction of the surface of the filling material 2 via the antenna arrangement 10. After reflection on the filling material surface, the level meter 1 receives the reflected radar signals R_{HF} again via the antenna arrangement 10. In this case, the signal transit time between transmission and reception of the respective radar signals S_{HF}, R_{HF} is proportional to the distance d between the level meter 1 and the filling material 2, wherein the signal transit time from the level meter 1 can be determined, for example, by means of the FMCW or by means of the pulse transit time method. Accordingly, the level meter 1 can, for example, on the basis of a corresponding calibration, assign the measured transit time to the given distance d. In this way, the fill-level measurement device 1 can according to

d=h−L

in turn determine the fill-level L, provided the installation height h is stored in the level meter 1.

As a rule, the level meter 1 is connected via an interface module accommodated in the device housing 13, such as “PROFIBUS,” “HART,” or “Wireless HART,” to a higher-level unit 4, such as a process control system. In this way, the fill-level value L can be transmitted, for example, in order to control the flow or discharge of the tank 3 if necessary. However, other information about the general operating state of the fill-level measuring device 1 can also be communicated.

As sketched in FIG. 2, the antenna arrangement 10 within the level meter 1 is activated by a high-frequency module 11, 12, 120. The FMCW or pulse transit time measuring principle, for example, is implemented in a suitably designed transceiver unit 11 of the high-frequency module 11, 12, 120 for determining the signal transit time on the basis of the incoming received signal R_{HF}. In addition, the transceiver unit 11 serves to generate the radar signal S_{HF} to be emitted. For this purpose, in the embodiment variant shown, the transceiver unit 11 is arranged within the meter neck 131, e.g., as a monolithically encapsulated SMD component, on a side, facing the antenna arrangement 10, of a printed circuit board.

The printed circuit board together with the transceiver unit 11 is enclosed by an electronics encapsulation 12 of the high-frequency module 11, 12, 120. The electronics encapsulation 12 can be manufactured from a plastic, such as PC, PE, PP, or PA. On the one hand, this makes it possible to additionally encapsulate the printed circuit board together with the transceiver unit 11 for explosion protection purposes by means of a potting compound (not explicitly shown in FIG. 2). On the other hand, the coupling of the transceiver unit 11 to the antenna arrangement 10 is made possible by means of the high-frequency module 11, 12, 120. For this purpose, in the embodiment shown in FIG. 2, the antenna arrangement comprises, as a high-frequency connection 100, a straight waveguide segment 100, by means of which the antenna arrangement 10 can be contacted by the high-frequency module 11, 12, 120 to allow high-frequency transmission.

To transmit the radar signals S_{HF}, R_{HF} from or to the transceiver unit 11, a likewise rectilinear waveguide segment 120, which, in the fully-assembled state of the level meter 1, extends orthogonally from the transceiver unit 11 towards the high-frequency connection 100 with respect to the printed circuit board, is assigned to the high-frequency module 11, 12, 120. The waveguide segment 120 in this case is attached via a screw connection 122 to a feedthrough 121 of the electronics encapsulation 12 in such a manner that the waveguide segment 120 is guided through the wall of the electronics encapsulation 12 to the outside. For this purpose, the waveguide segment 120 has an external thread aligned in the waveguide axis a around the cavity, so that the waveguide segment 120 is countered by a corresponding nut from the outside against the electronics encapsulation 12, as is the case in FIG. 2. Instead of the screw connection 122 shown in FIG. 2, the waveguide segment 120 can also be attached accordingly to the feedthrough of the electronics encapsulation 12 with an alternative fastening—for example, by means of pins. In addition, the printed circuit board on which the transceiver unit 11 is arranged within the electronics encapsulation 12 is mounted on the waveguide segment 120 by means of at least one fastening means. In this case, the fastening means can be an adhesive connection, or, again, a pin or screw connection. As a result, the printed circuit board or the transceiver unit 11 is self-supporting within the electronics encapsulation 12. That is to say, by means of the indirect fixation via the waveguide segment 120, the transceiver unit 11 does not require direct fixation to the electronics encapsulation 12. As a result, the printed circuit board and thus the electronics encapsulation 12 can be designed to be very compact overall, so that the accommodation of the high-frequency module 11, 12, 120 in the meter neck 131 is simplified.

As shown in FIG. 2, further printed circuit boards 15 can also be arranged within the electronics encapsulation 12 of the high-frequency module 11, 12, 120, in addition to the transceiver unit 11. As is shown in the illustration, these can be electrically connected to the printed circuit board on which the transceiver unit 11 is arranged, e.g., by means of a mechanically flexible cable harness. In this case, the transceiver unit 11 and any further printed circuit boards 15, for manufacturing the high-frequency module 11, 12, 120, can be inserted, e.g., by means of an assembly aid which is designed as a negative form of the transceiver unit 11 or the further printed circuit boards 15, from a side, opposite the feedthrough 121, of the electronics encapsulation 12.

In the assembled state of the level meter 1, i.e., as soon as the high-frequency module 11, 12, 120 is inserted into the meter neck 131, the high-frequency connection 100 designed as a waveguide and the waveguide segment 120 of the high-frequency module 11, 12, 120 sit flush with one another (or the high-frequency connection 100 and the waveguide segment 120 respectively adjoin a galvanic isolation 140 arranged between them) in such a way that the waveguide segments 100, 120 form a shared waveguide axis a.

As a result, a lossless transmission of the radar signals S_{HF} is achieved between the antenna arrangement 10 and the transceiver unit 11. Accordingly, in the embodiment shown in FIG. 2, the high-frequency module 11, 12, 120 is designed in such a way that the electronics encapsulation 12 is accordingly guided in the direction of the waveguide axis a of the waveguide segments 100, 120 upon insertion into the meter neck 131 (from the end region which faces away from the antenna arrangement 10). For this purpose, extending from the electronics encapsulation 12, a corresponding guide element 14 is formed in this region radially symmetrically around the second waveguide segment 120, corresponding to the inner wall of the meter neck 131.

The optional galvanic isolation 140 made of plastic or ceramic shown in FIG. 2 serves to electrically decouple the antenna arrangement 10 from the transceiver unit 11 or from the further electronic components in the device housing 13. For this purpose, the galvanic isolation 140 is arranged flush between the high-frequency connection 100 and the waveguide segment 120, wherein the galvanic isolation 140 is made of an electrically-insulating material such as a ceramic or a plastic and has a feedthrough corresponding to the internal cross-section of the waveguides 100, 120.

To ensure that the high-frequency connection 100 of the antenna arrangement 10 and the waveguide segment 120 of the high-frequency module 1, 12, 120 sit flush against one another or against the galvanic isolation 140 without gaps in the inserted state of the electronics encapsulation 12, according to the invention, a spring element 130 presses the electronics encapsulation towards the antenna arrangement 10, with guidance provided by the guide element 14, from the interior of the meter neck 131, in such a way that the waveguide segment 120 is pressed with the corresponding spring force against the waveguide of the high-frequency connection 100. This in turn ensures a lossless signal transmission. In the embodiment shown in FIG. 2, the spring element 130 is designed as a wave spring. In this case, the wave spring 130 is clamped in the interior of the meter neck 131 between a groove or a locking ring 132 and the outer side of the of the electronics encapsulation 12 which faces away from the waveguide segment 120.

In contrast to the embodiment variant shown in FIG. 2, it is, alternatively, also conceivable for the spring element 130, 133 to be designed as a tension spring 133, and to be clamped in the device neck 131 between the antenna arrangement 10 and the electronics encapsulation 12, in order to again pull the second waveguide segment 120 with the corresponding spring force against the first waveguide segment 100. Such a possibility for affixing the high-frequency module 11, 12, 120 according to the invention is illustrated in FIG. 3: In the embodiment shown there, on the outside of the electronics encapsulation 12, a spring ring 133 is provided at the height of the waveguide segment 120. In this case, the spring ring 133 is designed, when the high-frequency module 11, 12, 120 is inserted into the meter neck 131, to press from the inside against the guide element 14 of the electronics encapsulation 12 in such a manner that an annular outer bead of the guide element 14 engages outwards into a corresponding groove of the meter neck 131. In this case, the positions of the spring ring 133, the outer bead, and the groove are selected to be far enough beneath that the waveguide segment 120 is in turn pressed with a defined tensile stress against the high-frequency connection 100 of the antenna arrangement 10, leaving no gap.

Regardless of the design of the spring element 130, 133 as a tension spring 133 or as a compression spring 130, the clamping, in addition to the gap-free sealing between the waveguides 100, 120, also causes the electronics encapsulation 12 to be fixed within the meter neck 12. In this connection, the pressing according to the invention of the waveguide segment 120 against the high-frequency connection 100 can also be implemented if the electronics encapsulation 12 is accommodated directly in the device housing 13. This may be the case if the device housing 13 of the level meter 1 does not comprise a meter neck 131, or if the waveguide-shaped, high-frequency connection 100 extends through the entire meter neck 131. In addition, the pressing according to the invention of the individual waveguide segments 100, 120 can also be implemented if they are not designed as waveguides, but rather, for example, as dielectric waveguides.

### LIST OF REFERENCE SIGNS

1 Level meter
2 Filling material
3 Tank
4 Superordinate unit
10 Antenna arrangement
11 Transceiver unit
12 Electronics encapsulation
13 Device housing
14 Guide element
15 Printed circuit board
100 High-frequency connection of the antenna arrangement
120 Waveguide segment of the high-frequency module
121 Feedthrough in the electronics encapsulation
122 Screw connection
130 Spring element
131 Meter neck
132 Locking ring
133 Spring washer
140 Galvanic isolation
a Waveguide axis
d Distance
h Installation height
L Fill-level
R_{HF} Reflected radar signal
S_{HF} Radar signal

1-9. (canceled)

10. A high-frequency module for a radar-based level meter which serves to determine a fill-level of a filling material, comprising:
a transceiver unit which is designed to generate radar signals, and, after reflection of the radar signals on the filling material surface, to determine the fill-level from corresponding received signals;
an electronics encapsulation in which the transceiver unit is arranged; and
a waveguide segment which is connected to the transceiver unit to transmit the radar signals,
wherein the waveguide segment is attached to a feedthrough of the electronics encapsulation such that the waveguide segment is guided out of the electronics encapsulation, and
wherein the transceiver unit is attached to the waveguide segment.

11. The high-frequency module according to claim 10, wherein the waveguide segment is attached to the feedthrough of the electronics encapsulation using a screw connection.

12. The high-frequency module according to claim 11, wherein the screw connection on the waveguide segment has an external thread oriented along the waveguide axis, such that the waveguide segment is countered by a corresponding nut against the feedthrough of the electronics encapsulation.

13. The high-frequency module according to claim 10, wherein the transceiver unit is arranged on a printed circuit board, and wherein the transceiver unit is fastened to the waveguide segment via the printed circuit board.

14. The high-frequency module according to claim 10, wherein the transceiver unit is cast inside the electronics encapsulation with a potting compound.

15. A radar-based level meter for determining a fill-level of a filling material, comprising:
a high-frequency module, including:
a transceiver unit which is designed to generate radar signals, and, after reflection of the radar signals on the filling material surface, to determine the fill-level from corresponding received signals;
an electronics encapsulation in which the transceiver unit is arranged; and
a waveguide segment which is connected to the transceiver unit to transmit the radar signals,
wherein the waveguide segment is attached to a feedthrough of the electronics encapsulation such that the waveguide segment is guided out of the electronics encapsulation, and
wherein the transceiver unit is attached to the waveguide segment;
an antenna arrangement which can be activated via a high-frequency connection, such that the radar signal can be emitted towards the filling material, and, after reflection of the radar signal on the filling material surface, a received signal can be received; and
a device housing, connected to the antenna arrangement, in which the high-frequency module is arranged in such a manner that the waveguide segment connects to the high-frequency connection with a positive connection along a waveguide axis.

16. The level meter according to claim 15, wherein the device housing is connected to the antenna arrangement via a meter neck in which the high-frequency module is arranged.

17. The level meter according to claim 15, wherein the high-frequency connection and the waveguide segment are designed as waveguides.

18. The level meter according to claim 15, wherein a galvanic isolation with a positive connection on both ends is arranged between the high-frequency connection and the waveguide segment.
